(19) United States
(12) Patent Application Publication
(10) Pub. No.: US 2012/0059752 A1
(43) Pub. Date: Mar. 8, 2012

(54) POST TRADE HANDLING MODULE AND A METHOD THEREIN

(75) Inventors: Daniel JENSEN, Saltsjo-Boo (SE); Tobias HALLOR, Stockholm (SE)

(73) Assignee: OMX TECHNOLOGY AB, Stockholm (SE)

(21) Appl. No.: 12/875,388

(22) Filed: Sep. 3, 2010

(51) Int. Cl. G06Q 40/00

(52) U.S. Cl. 705/37

(57) ABSTRACT

The invention relates to a method in a post trade handling module (23) for handling an offering data set in a data network. The post trade handling module is comprised in a computerized trading system (10). The computerized trading system (10) further comprises a reference database (20) comprising at least one offering data set, and a matching engine module (21) arranged to match an offering data set from the reference database (20) with a data request from a requesting node (12) in the data network. The matched offering data set is to be accepted by the requesting node (12).

The post trade handling module receives an offering data set from the matching engine module (21). The offering data set has been accepted by the requesting node (12) and indicates a time period. The post trade handling module further computes a number of split offering data sets by splitting the offering data set based on the indicated time period, each split offering data set indicates a shorter time period than the time period in the offering data set. In addition, the post trade handling module transmits each split offering data set to a receiver node (14) in the data network enabling the receiver node (14) to handle the offering data set.

### TECHNICAL FIELD

The invention relates to a method in a post trade handling module and a post trade handling module in a computerized trading system. In particular, for handling an offering data set in a data network.

### BACKGROUND

In a typical computerized trading system of today each offering data set, such as a tradable instrument, is configured in a central part of the computerized trading system. If there are many different types of tradable instruments with different configuration, a large number of tradable instruments require setup and configuration in a number of modules of the computerized trading system, having a great impact on system performance. The system will be slow and require a lot of resources when running the system as well as when cleaning up files during night stops or similar situations. Thus, set up of tradable instruments requires a lot of performance from the computerized trading system. For every tradable instrument a unique configuration must exist in the system.

### SUMMARY

An object of embodiments herein is to provide a mechanism that enables offering data sets, also known as tradable instruments, to be created in an efficient manner.

According to an aspect of embodiments herein the object is achieved by providing a method in a post trade handling module for handling an offering data set in a data network. The post trade handling module is comprised in a computerized trading system.

The computerized trading system further comprises a reference database comprising at least one offering data set, and a matching engine module. The matching engine module is capable of matching an offering data set from the reference database with a data request from a requesting node in the data network. The matched offering data set is to be accepted by the requesting node. The post trade handling module receives an offering data set from the matching engine module. The offering data set has been accepted by the requesting node and the offering data set indicates a time period.

The post trade handling module computes a number of split offering data sets by splitting the offering data set based on the indicated time period. Each split offering data set indicates a shorter time period than the time period in the offering data set. The post trade handling module then transmits each split offering data set to a receiver node in the data network. The split offering data sets enables the receiver node to handle the offering data set.

In order to perform the method a post trade handling module is provided. The post trade handling module for handling an offering data set in a data network is comprised in the computerized trading system. The computerized trading system further comprises the reference database comprising at least one offering data set, and the matching engine module. The matching engine module is arranged to match an offering data set from the reference database with a data request from a requesting node in the data network. The matched offering data set is to be accepted by the requesting node.

The post trade handling module comprises a receiving circuit arranged to receive an offering data set from the matching engine module. The offering data set has been accepted by the requesting node and indicates a time period. The post trade handling module further comprises a computing circuit configured to compute a number of split offering data sets by splitting the offering data set based on the indicated time period. Each split offering data set indicates a shorter time period than the time period in the offering data set. The post trade handling module also comprises a transmitting circuit configured to transmit each split offering data set to a receiver node in the data network. The split post trade handling module enables the receiver node to handle the offering data set.

Embodiments herein require fewer offering data sets to be configured in the reference database, but still provide the desired number of split offering data sets going out from the system by performing the splitting in the post trade handling module. Thus, embodiments herein will not require multiple split offering data sets in the computerized trading system to be created to generate the desired number of split offering data sets which will a have positive impact on performance utilization.

### BRIEF DESCRIPTION OF THE DRAWINGS

Embodiments will now be described in more detail in relation to the enclosed drawings, in which:

FIG. 1 is a schematic diagram depicting a computerized trading system in a data network,

FIG. 2 is a block diagram depicting a computerized trading system,

FIG. 3 is a block diagram depicting a hierarchic data structure in a module,

FIG. 4 is a block diagram depicting a flow chart in a post trade handling module,

FIG. 5 is a schematic overview depicting a post trade handling module in the computerized trading system.

### DETAILED DESCRIPTION

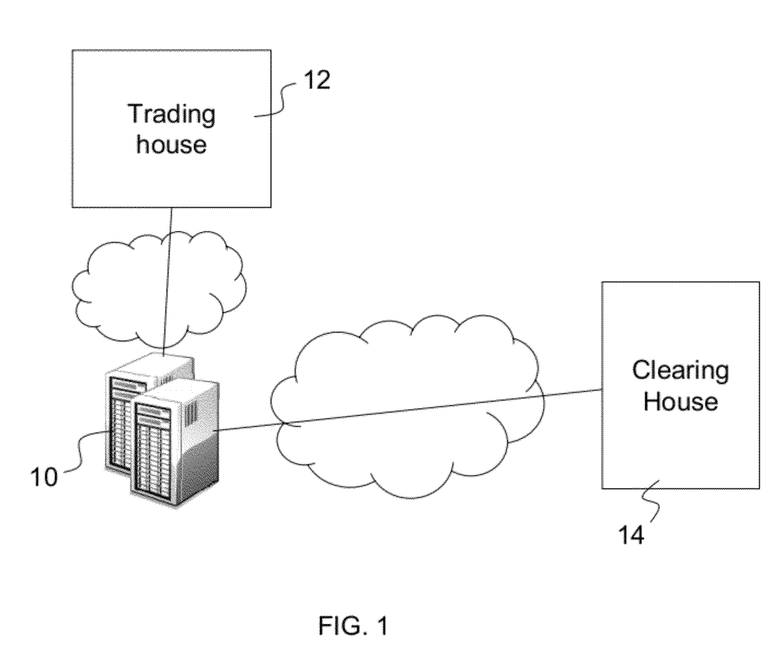

FIG. 1 shows an example of a computerized trading system 10 in a data network. The computerized trading system 10 may provide different offering data sets to a requesting node, such as a trading house 12. The offering data set may comprise a repurchase agreement; also know as a Repo Agreement. The repo agreement allows a user in the trading house 12 to use a financial security as collateral for a cash loan at a fixed interest rate. In a repo agreement, the user agrees to buy the same security from the owner of the offering data set at a fixed price at some later date.

The offering data set indicates a time period, for example, the term of the repo agreement, and may also indicate a financial amount and an interest rate.

At the trading house 12, a user, also referred to as a buyer, requests an amount to borrow over a period of time. The computerized trading system then matches the request from the trading house 12 with stored offering data sets in the computerized trading system 10. Matched offering data sets are displayed to the user at the trading house 12. The user then accepts one offering data set that may indicate a time period, an amount of financial value and an interest rate.

It is herein provided a mechanism that creates a few tradable instruments referred to herein as offering data sets, that will be used to generate multiple number of tradable instruments with unique configuration when needed at trade execution. This is enabled by providing in a post trade handling module of the computerized trading system 10 a mechanism that splits an offering data set that has been accepted by the trading house 12. The offering data set is split based on the indicated time period wherein each split offering data set indicates a shorter time period than the time period in the offering data set. For example, the post trade handling module may split an offering data set based on the number of settlement days of the indicated time period in the offering data set. The split offering data sets are transmitted to a receiver node illustrated as a clearing house 14. The clearing house 14 may then use the split offering data sets to facilitate the netting of different offering data sets. Thereby, the split offering data sets may more easily cancel out other split offering data sets, resulting in decreased credit exposure, and reduced both operational and settlement risk and operational costs.

It should be noted that a split offering data set may in some embodiments be represented by an individual trade message. An individual trade message may provide some actors of the computerized trading system with improved balance sheet netting of repos. Actors in a trading system may be such entities such as trading agents, trading houses, clearing houses, stock exchanges, companies for which trading instruments are provided, authorities, information vendors etc. For this individual trade message, an offering data set represented by a packeted term trade message is transacted in an originating repo data set, but instead of staying as the packeted term trade message, it is instead broken into a series of overnight individual trade messages, with interest paid daily.

For example, a packeted term trade message of a four day originating repo data set with a Start date T and an End date T+4 is broken down into four separate individual trade messages:

Individual trade message 1: Start date T and End date T+1

Individual trade message 2: Start date T+1 and End date T+2
Individual trade message 3: Start date T+2 and End date T+3
Individual trade message 4: Start date T+3 and End date T+4.

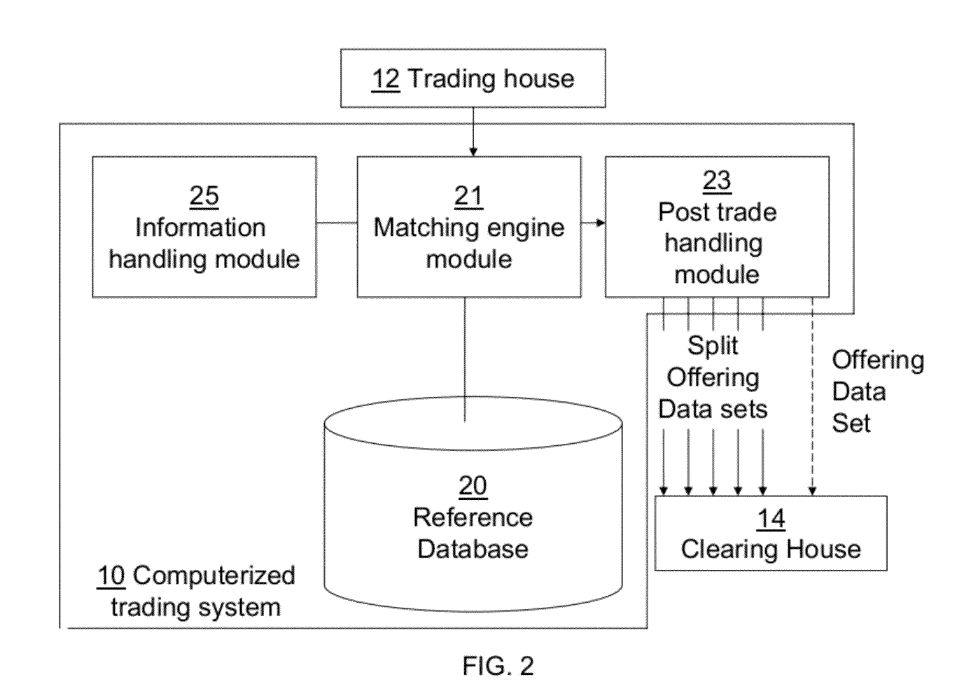

FIG. 2 is a schematic overview of an example of the computerized trading system 10. In complex computer systems, such as in trading systems, different modules are used to provide different functionalities. The different modules share data in various data fields that are stored in a database, also referred to as a reference database 20. System data set in the reference database 20 may comprise reference data for the different modules, where such reference data may be definitions of instruments traded, definitions of specific instruments, various limits for instruments etc; referred to herein as offering data sets.

In the illustrated computerized trading system 10 there are a number of modules 21, 23, and 25. Each of the modules is of a different type that provides a number of activities for a number of actors related to the system. The illustrated computerized trading system comprises a market module, also referred to as a matching engine module 21. In the matching engine module 21 an actual trading application is provided wherein an offering data set, such as a repo agreement, is matched to a request from the trading house 12. The offering data set is provided from the reference database 20. The user of the trading house 12 may then accept the offering data set.

The offering data set, when accepted, is then transmitted to a post trade handling module 23. According to embodiments of the present solution, the post trade handling module 23 is arranged to split the offering data set into split offering data sets indicating a shorter time period than the time period indicated in the offering data set. The split offering data sets are then transmitted to the clearing house 14 or another receiver node in the data network. The offering data set, that is, the original accepted offering data set, may also be transmitted to the clearing house 14 or to any other receiver node.

The offering data set may indicate borrowing amount of financial value, interest rate, a start date, an end date, interest amount of financial value for the term between start and end date, transaction id, a price indication and/or similar. The split offering data set may indicate borrowing amount, interest rate, a start date, an end date, interest amount for the term between start and end date, transaction id, a price indication and/or similar.

Thus, the split offering data set may have the same data field structure as the offering data set, but may also include new fields for identifying length of term, identifying that it is a split offering data set of the offering data set and/or the like.

Furthermore, in FIG. 2 an information handling module 25 is illustrated. The information handling module 25 provides information regarding the trading performed, like sending out current prices or other information.

A new configuration parameter, also referred to as a template index, may be added to the reference database 20 that will enable the present split functionality. The post trade handling module 23 may then be modified to distribute split offering data sets, such as individual trade messages, and offering data set, such as a repo trade based on a configuration comprising the new configuration parameter retrieved from the reference database 20. The functionality of splitting offering data set may be enabled or disabled by an actor. Also, the split offering data set as well as the original offering data set may be distributed to any actor in the trade identified in the trade or indicated in the computerised trading system 10.

A split offering data set may be set to be stored a number of days after end date. An offering data set may also be stored in the post trade handling module 23 a number of days after the end date of the term. The required time and resources to delete offering data sets during clean up may not be affected when implementing a split offering data set functionality. Depending on the length of the term, there could be split offering data sets that expire before the offering data set and will therefore be removed before. Thus, the deletion is performed more often in using split offering data sets than using the offering data sets that is stored over a longer time.

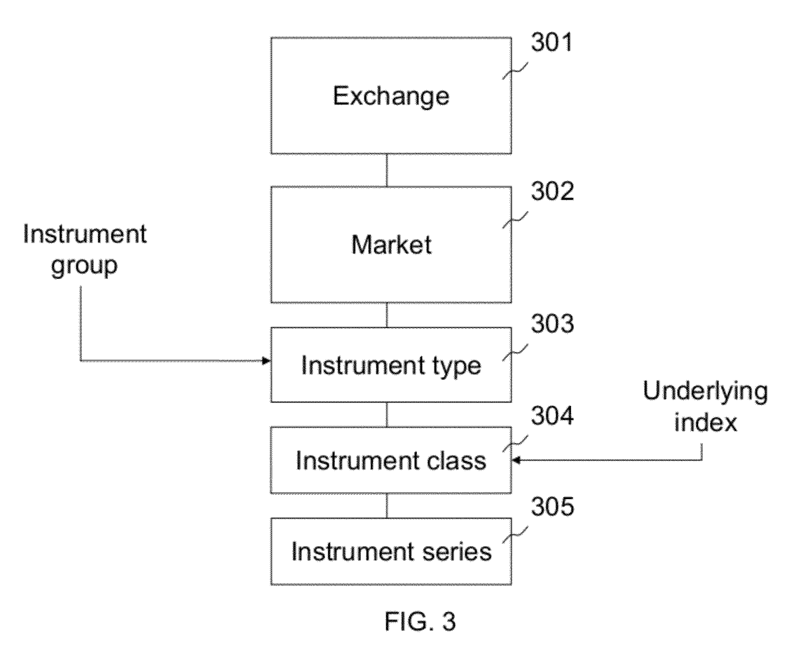

FIG. 3 shows the hierarchic data structure used in the computerized trading system 10. By providing a hierarchic data structure for offering data sets, exemplified as tradable instruments in the figure, the creation of a tradable instrument is provided in an efficient manner. The hierarchic data structure is set up in the reference data base 20 and retrieved by the post trade handling module 23 during start up or during continuous updating.

The hierarchic data structure comprises the top level referred to as an exchange level 301. Exchange types participating in trading are here defined. Underlying the exchange level 301 is a market level 302. Market types are connected to an exchange type responsible for administering a trading. A market level index inherits all settings or attributes from a connected exchange type in the exchange level 301. A market type regulates trading, clearing and settlement days, as well as holidays as defined in, for example, a Holiday table that may be connected to the market type.

An instrument type level 303 is arranged below the market level 302. All tradable instruments are connected to a certain instrument group. By combining a market type with an instrument group, an instrument type is created. An instrument type is connected to a certain market type and inherits all the settings or attributes of the connected certain market type.

An instrument class level 304 is arranged below the instrument type level 303. An instrument class gives a general classification of a traded instrument. The Instrument class inherits all the setting or attributes of a connected instrument type. A provided underlying index determines an underlying asset of a traded instrument. Each underlying asset is also connected to an instrument class and the instrument class is given parameters such as rules for naming instruments, automatic series generation, etc. An underlying index may be connected to several instrument classes.

An instrument series level 305 is arranged below the instrument class level 304. An instrument series inherits all the setting or attributes of the instrument class to which the series is connected. Anything that is traded and/or subject to clearing is considered an instrument.

Thus, the adding of new instruments is facilitated as one only needs to find an existing instrument in the hierarchy that has all the settings or attributes of the new instrument. The new instrument is then placed on a level in the hierarchy of the hierarchic module structure which is below the existing instrument and a link is created between the new instrument and the existing instrument.

A new tradable instrument may be setup in the reference database 20 to split an offering data set, for example, a packeted term trade message. The new tradable instrument may be added in the hierarchy, for example, in the market level 302. According to embodiments herein the new tradable instrument is only executed at the post trade handling module 23, thereby limiting the number of instruments required to be setup in the computerized trading system. Hence, the post trade handling module 23 will split the packeted term trade message into individual trade messages. The offering data set is identified as an offering data set to be split by a template index. The template index is stored in the post trade handling module 23 and received from the reference database 20 in the computerized trading system 10 when retrieving the hierarchic data structure during start up, update or the like.

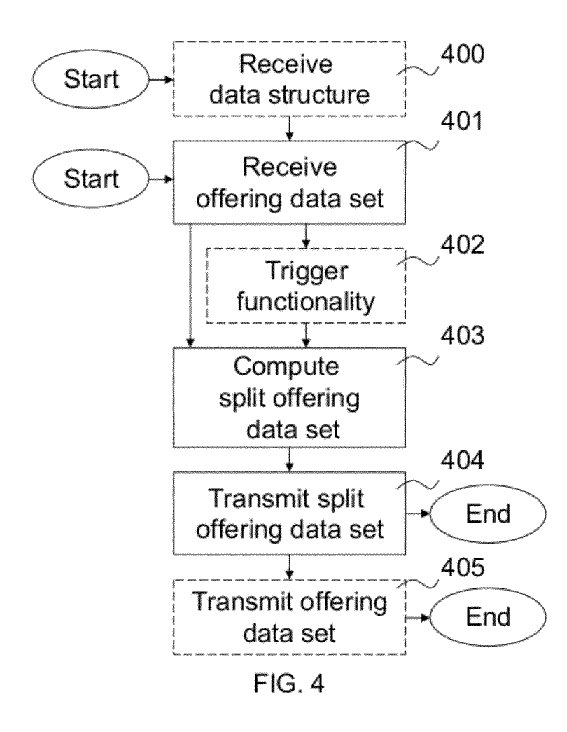

The method steps in the post trade handling module 23 for handling an offering data set in a data network according to some general embodiments will now be described with reference to a flowchart depicted in FIG. 4. The steps do not have to be taken in the order stated below, but may be taken in any suitable order. The post trade handling module is comprised in a computerized trading system. The computerized trading system further comprises a reference database 20 and a matching engine module 21. The reference data base module comprises at least one offering data set and the matching engine module 21 is capable of matching an offering data set from the reference database 20 with a data request from a requesting node 12 in the data network. The matched offering data set is to be accepted by the requesting node 12, such as a trading house.

### Step 400

This step is optional as indicated by the dashed line. The post trade handling module 23 may receive a template index from the reference database 20 in the computerized trading system 10. This may be performed during start up, an update or the like, where the post trade handling module 23 retrieves data configuration from the reference database 20. The template index may be stored in the post trade handling module 23. The post trade handling module 23 may in some embodiments comprise a hierarchic data structure of instruments, which hierarchic data structure comprises a classification structure of levels. Each level of instruments inherits settings or attributes of an instrument of a higher level and the template index may be stored at one of the levels.

### Step 401

The post trade handling module 23 receives an offering data set from the matching engine module 21. The offering data set has been accepted by the requesting node 12 and indicates a time period. For example, the offering data set may be represented by a financial instrument such as a repo trade with a term of five days. The post trade handling module 23 may receive the repo trade once accepted by the requesting node 12.

The time period may be a period of days indicated by a start date and an end date of time indicating a number of settlement days.

### Step 402

This step is optional as indicated by the dashed line. The post trade handling module 23 is triggered to initiate a split functionality when the offering data set comprises the template index. That is, the post trade handling module 23 initiate the computing step 403 below when the template index in the offering data set is detected. The template index may be compared with an index of the offering data set to determine when a match is found to trigger the computing step 403.

### Step 403

The post trade handling module 23 computes a number of split offering data sets by splitting the offering data set based on the indicated time period. Each split offering data set indicates a shorter time period than the time period in the offering data set. The post trade handling module 23 may split the offering data set based on the number of settlement days indicated in the offering data set. The settlement days may be taken from a stored calendar or table in the post trade handling module 23. For example, a packeted term trade message of seven days may be split into four overnight trade messages and one weekend trade message.

In some embodiments, the offering data set may indicate an amount of financial value and an interest rate for the amount of financial value. The split offering data set may indicate a split amount of financial value and a term interest rate which is the same interest rate as in the offering data set.

In some embodiments, the split offering data set may be stored in the post trade handling module 23 for a preset number of days.

### Step 404

The post trade handling module 23 transmits each split offering data set to a receiver node 14 in the data network enabling the receiver node 14 to handle the offering data set. For example, the split offering data sets may facilitate netting at the receiver node 14 cancelling out offering data sets.

### Step 405

This is an optional step as indicated by the dashed line. The post trade handling module 23 may in some embodiments also transmit the offering data set. That is the offering data set received from the matching engine module 21.

In some embodiments, the post trade handling module 23 may comprise a deal capture post trading module.

Embodiments herein provide a mechanism that enables efficient handling at the receiver node 14 by creating split offering data sets. By implementing the creation of split offering data sets after trading is accepted, the creation of split offering data sets is efficiently performed as the set up of tradable instruments doe not require a lot of performance from the computerized trading system.

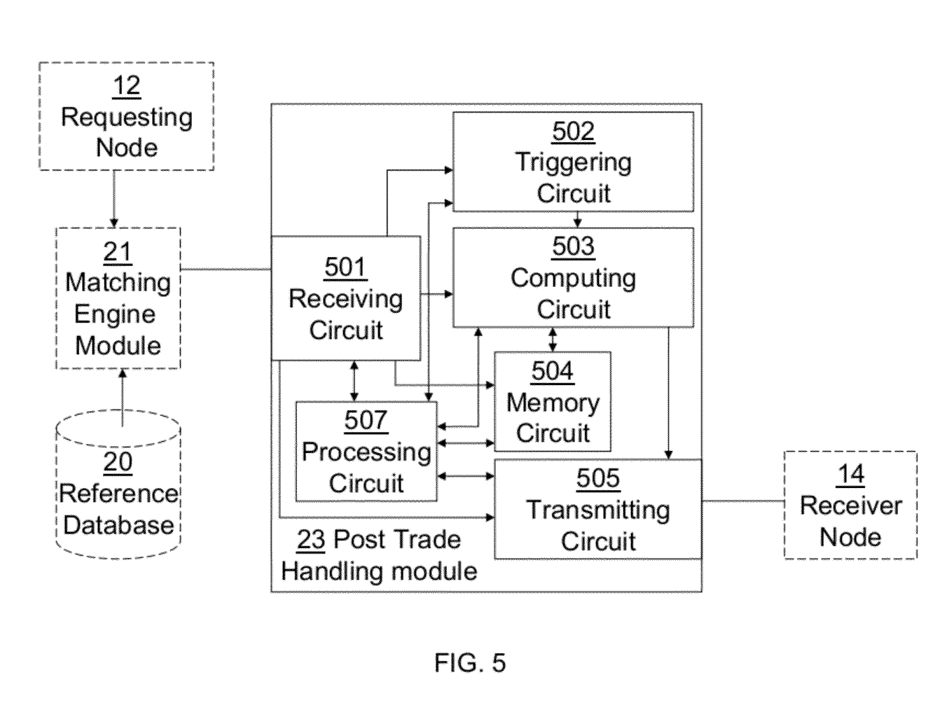

In order to perform the method a post trade handling module 23 for handling an offering data set in a data network is provided. In FIG. 5 the post trade module 23 is schematically illustrated. The post trade handling module 23 is adapted to be comprised in a computerized trading system 10. The computerized trading system 10 further comprises a reference database 20 comprising at least one offering data set. The computerized trading system further comprises a matching engine module 21 arranged to match an offering data set from the reference database 20 with a data request from a requesting node 12 in the data network. The matched offering data set is to be accepted by the requesting node 12.

The post trade handling module 23 comprises a receiving circuit 501 arranged to receive an offering data set from the matching engine module 21. The offering data set has been accepted by the requesting node 12 and the offering data set indicates a time period. The time period may indicate term length of the offering data set. The receiving circuit 501 may in some embodiments be configured to receive a template index from the reference database 20 in the computerized trading system 10. The post trade handling module 23 may comprise a hierarchic data structure of instruments, which hierarchic data structure comprises a classification structure of levels. Each level of instruments inherits settings or attributes of an instrument of a higher level, and the template index is stored at one of the levels.

The post trade handling module 23 may in some embodiments further comprise a triggering circuit 502 configured to trigger a computing circuit 503 to compute as stated below when the offering data set comprises the template index.

The post trade handling module 23 further comprises the computing circuit 503 configured to compute a number of split offering data sets by being arranged to split the offering data set based on the indicated time period. Each split offering data set indicates a shorter time period than the time period in the offering data set. The time period may be a period of days indicated by a start date and an end date of time indicating a number of settlement days. The computing circuit 503 may be arranged to split the offering data set based on the number of settlement days.

The template index may be stored in a memory circuit 504 of the post trade handling module 23.

The post trade handling module 23 also comprises a transmitting circuit 505 configured to transmit each split offering data set to a receiver node 14 in the data network enabling the receiver node 14 to handle the offering data set.

In some embodiments, the offering data set indicates an amount of financial value and an interest rate for the amount of financial value. For example, the offering data set may be represented by a Repo Agreement message. The split offering data set may indicate a split amount of financial value and a term interest rate which is the same interest rate as the offering data set.

In some embodiments, the memory circuit 504 may be arranged to be used to store the split offering data for a preset number of days.

The post trade handling module 23 may be represented by a deal capture post trading module.

In some embodiments, the transmitting circuit 505 may further be arranged to transmit also the offering data set to the receiver node 14.

The present mechanism for handling an offering data set may be implemented through one or more processors, such as a processing circuit 507 in the post trade handling module 23 in the computerized trading system 10 depicted in FIG. 5, together with computer program code for performing the functions of the present solution. The program code mentioned above may also be provided as a computer program product, for instance in the form of a data carrier carrying computer program code for performing the present solution when being loaded into the post trade handling module 23. One such carrier may be in the form of a CD ROM disc. It is however feasible with other data carriers such as a memory stick.

In the drawings and specification, there have been disclosed exemplary embodiments of the invention. However, many variations and modifications can be made to these embodiments without substantially departing from the principles of the present invention. Accordingly, although specific terms are employed, they are used in a generic and descriptive sense only and not for purposes of limitation, the scope of the invention being defined by the following claims.

1. A method in a post trade handling module (23) for handling an offering data set in a data network, which post trade handling module is comprised in a computerized trading system (10) that further comprises a reference database (20) comprising at least one offering data set, and a matching engine module (21) capable of matching an offering data set from the reference database (20) with a data request from a requesting node (12) in the data network, which matched offering data set is to be accepted by the requesting node (12), the method comprises;
receiving (401) an offering data set from the matching engine module (21), which offering data set has been accepted by the requesting node (12) and which offering data set indicates a time period,
computing (403) a number of split offering data sets by splitting the offering data set based on the indicated time period, each split offering data set indicating a shorter time period than the time period in the offering data set, and
transmitting (404) each split offering data set to a receiver node (14) in the data network enabling the receiver node (14) to handle the offering data set.

2. A method according to claim 1, wherein the time period is a period of days indicated by a start date and an end date indicating number of settlement days, and wherein the computing step splits the offering data set based on the number of settlement days.

3. A method according to claim 1, wherein the offering data set indicates an amount of financial value and an interest rate for the amount of financial value, and wherein the split offering data set indicates a split amount of financial value and a term interest rate which is the same interest rate as in the offering data set.

4. A method according to claim 1, further comprising,
receiving (400) a template index from the reference database (20) in the computerized trading system (10), and
triggering (402) the computing step (403) when the offering data set comprises the template index.

5. A method according to claim 4, wherein the post trade handling module (23) comprises a hierarchic data structure of instruments, which hierarchic data structure comprises a classification structure of levels, wherein each level of instruments inherits settings or attributes of an instrument of a higher level, and wherein the template index is stored at one of the levels.

6. A method according to claim 1, wherein the split offering data set is stored in the post trade handling module (23) for a preset number of days.

7. A method according to claim 1, wherein the post trade handling module (23) comprises a deal capture post trading module.

8. A method according to claim 1, further comprising
transmitting (405) also the offering data set to the receiver node (14).

9. A post trade handling module (23) for handling an offering data set in a data network, which post trade handling module is arranged to be comprised in a computerized trading system (10) that further comprises a reference database (20) comprising at least one offering data set, and a matching engine module (21) arranged to match an offering data set from the reference database (20) with a data request from a requesting node (12) in the data network, which matched offering data set is to be accepted by the requesting node (12), the post trade handling module (23) comprises;
a receiving circuit (501) arranged to receive an offering data set from the matching engine module (21), which offering data set has been accepted by the requesting node (12) and which offering data set indicates a time period,
a computing circuit (503) configured to compute a number of split offering data sets by splitting the offering data set based on the indicated time period, each split offering data set indicates a shorter time period than the time period in the offering data set, and
a transmitting circuit (505) configured to transmit each split offering data set to a receiver node (14) in the data network enabling the receiver node (14) to handle the offering data set.

10. The post trade handling module according to claim 9, wherein the time period is a period of days indicated by a start date and an end date indicating a number of settlement days, and the computing circuit (503) is arranged to split the offering data set based on the number of settlement days.

11. The post trade handling module according to claim 9, wherein the offering data set indicates an amount of financial value and an interest rate for the amount of financial value, and the split offering data set indicates a split amount of financial value and a term interest rate which is the same interest rate as the offering data set.

12. The post trade handling module according to claim 9, wherein the receiving circuit (501) is further configured to receive a template index from the reference database (20) in the computerized trading system (10), and the post trade handling module (23) further comprises a triggering circuit (502) configured to trigger the computing circuit (503) to compute the number of split offering data sets when the offering data set comprises the template index.

13. The post trade handling module according to claim 12, wherein the post trade handling module (23) comprises a hierarchic data structure of instruments, which hierarchic data structure comprises a classification structure of levels, wherein each level of instruments inherits settings or attributes of an instrument of a higher level, and the template index is stored at one of the levels.

14. The post trade handling module according to claim 9, further comprising a memory circuit (504) arranged to be used to store the split offering data sets for a preset number of days.

15. The post trade handling module according to claim 9, wherein the post trade handling module (23) is represented by a deal capture post trading module.

16. The post trade handling module according to claim 9, wherein the transmitting circuit (505) is further arranged to transmit also the offering data set to the receiver node (14).
